(19) United States
(12) Patent Application Publication
(10) Pub. No.: US 2004/0265410 A1
(43) Pub. Date: Dec. 30, 2004

(54) Mould sealing unit for an injection moulding machine

(76) Inventor: Karl Hehl, Lossburg (DE)

Correspondence Address: CANTOR COLBURN, LLP, 55 GRIFFIN ROAD SOUTH, BLOOMFIELD, CT, 06002

(21) Appl. No.: 10/492,459

(22) PCT Filed: Oct. 22, 2002
(86) PCT No.: PCT/EP02/11781

(30) Foreign Application Priority Data
Oct. 24, 2001 (DE) 101 51 352.6

(51) Int. Cl. B29C 45/66

(52) U.S. Cl. 425/169; 425/150; 425/589; 425/593

(57) ABSTRACT

A sealing device (12) is provided for the cyclical opening and closing of the injection mould (M) and for applying the sealing force on a mould sealing unit on an injection moulding machine for the working of plastics. The sealing device is supported on a support. A high resolution surface deflection sensor (13) is provided as sensor means for recording the tool securing force and the sealing force, which is arranged on the support for the sealing device (12). A simple, economic and reliable measuring system is thus achieved, which can record the forces throughout the whole cycle.

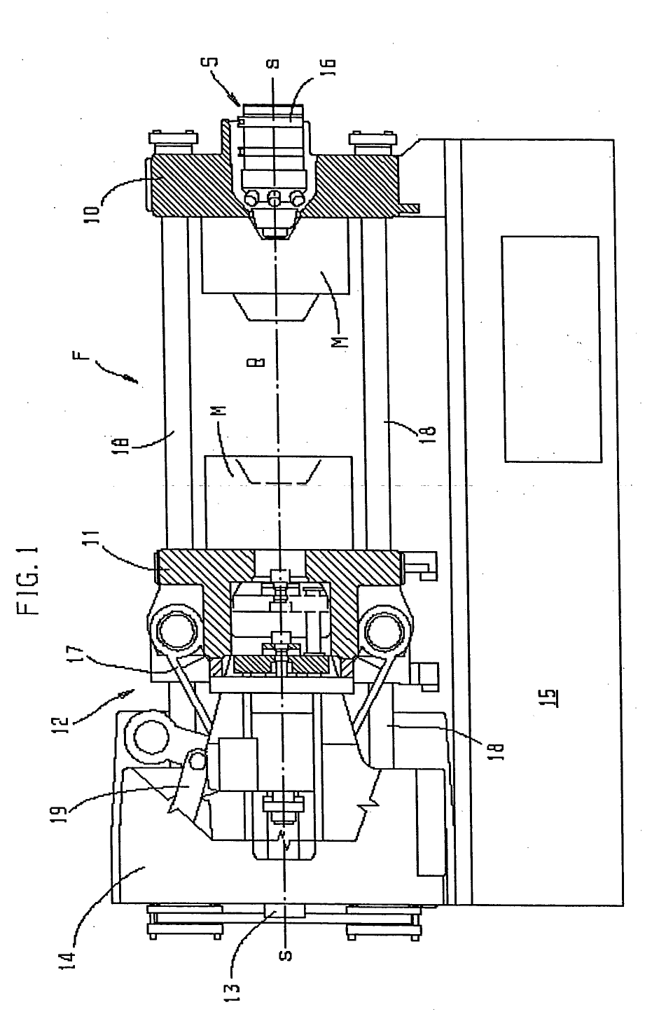

### REFERENCE TO RELATED APPLICATIONS

The present application claims the priority of German Patent Application 101 51 532.6, filed on 24 Oct. 2001, the disclosure content of which is hereby expressly also made the object of the present application.

### FIELD OF THE INVENTION

The invention relates to a mould closing unit for an injection moulding machine for the processing of plastics materials and other plasticisable substances.

### STATE OF THE ART

A mould closing unit of this type is known, for example, from EP 0 024 518 A1. There several deformation measurement devices are provided for the detection of the closing and holding forces at the supporting means of the closing unit to measure the deflection of the supporting means. Strain gauges are also provided as deformation measuring devices if additional auxiliary means like a tension bar are provided between the measuring points. It remains open whether all forces occurring during the injection process are measured therewith and how good the resolution of the sensor is therewith.

In JP 09 254 218 A strain gauges are provided in the region of a toggle mechanism. The disadvantage of the disposition of a sensor in the driving strand of the toggle, however, is that the transmission ratio of the toggle also has to be taken into account in a dynamic manner. The attachment to a displaced part at high acceleration forces, where applicable high temperature fluctuations and even the supply line under mechanical strain, are considerable disadvantages for the measuring principle.

In the case of other known, directly driven hydraulic injection moulding machines, both the mould securing force and also the closing force/holding force can be monitored by the hydraulic pressure. This is not possible in the case of injection moulding machines with toggle drives or other cinematic force transferring means such as eccentrics or cranks. In this case, the quasi-static closing force and the dynamic mould securing force (mould protection force) are measured by various sensors at various locations. The experts are of the opinion that it is not possible, using conventional sensors, to use the same sensor means for realising the requirements for a high closing force with at the same time high resolution for measuring a sufficiently precise mould securing force.

Current sensors for measuring the mould securing force are piezo-resistive systems, semiconductor strain gauges, which also resolve slight strains very well. However, in order not to overstrain the measuring element of the sensor for the mould securing force, the sensor is disposed, for the most part, at a location at which the high closing force does not become effective.

Current sensors for measuring the closing force, that is also the holding force, are strain gauges-strain rings for the guide bars, guide bar strain dowels and piezo-electric or piezo-resistive sensors.

The DSRT 1200 strain link made by Baumer Sensopress, for example, is known as a surface strain sensor. This is a surface strain sensor with an integrated amplifier for static applications. This strain transformer has a mechanical strain amplification by the factor 4. According to the specifications in the enclosed product sheet, it is suitable both for presses with long cycle times and for weight measurements and also for strain measurement on rigid structures. This excludes, in principle, the suitability for injection moulding machines with short cycle times.

### SUMMARY OF THE INVENTION

Proceeding from this state of the art, exemplary embodiments of the invention provide for a simple, economical and nevertheless reliable measuring system, which can detect both the mould securing force and the closing force sufficiently exact.

Exemplary embodiments of the invention include: a mould closing unit for an injection moulding machine for the processing of plastics materials and other plasticizable substances, said mould closing unit including a stationary mould carrier, which together with a movable mould carrier forms a mould clamping space for the accommodation of an injection mould, at least one closing device for the cyclical opening, supplying and closing of the injection mould by moving the movable mould carrier and for the applying of the closing force, a support for the closing device, a strain sensor for detecting at least the closing forces occurring when the injection mould is closed wherein the strain sensor is disposed on the support of the closing device, wherein the strain sensor for detecting both the mould securing force and the closing forces is one high resolution surface strain sensor that comprises only one measuring range for detecting the forces.

Additional exemplary embodiments of the invention include: a method for detecting the forces on a mould closing unit with a high resolution surface strain sensor, which is disposed on the support of the closing device and measures with mechanical amplification and with no reset and with only one measuring range.

Contrary to the opinion of the experts, a high resolution sensor is used, that-is-to-say a sensor, which is also definitely suitable for determining the mould securing force in a sufficiently precise manner. Nevertheless, the same sensor is also suitable for detecting the closing forces with one and the same measuring range. The suitability for the two purposes is achieved, amongst other things, by means of the location of the sensor, namely in the region of the supporting means of the closing device. Consequently, it is located on a substantially non-displaced part of the closing unit, which means that it is at least not exposed to dynamic influences. The advantage of the attaching is that, apart from good accessibility, the mechanical load at this part is clearly less with a smaller mechanical strain. Measuring errors when measuring the mould securing force, caused by lack of plate parallelity or injection parts clamped on one side, are minimised by the position of the sensor.

### BRIEF DESCRIPTION OF THE FIGURES

An exemplary embodiment of the invention is described in more detail below by way of an exemplified embodiment represented in the single FIGURE. The FIGURE is a side view in partial section of a mould closing unit of an injection moulding machine for processing plastics materials.

### DETAILED DESCRIPTION

An exemplary embodiment of the invention is now described in more detail as an example with reference to the enclosed drawings. However, the exemplified embodiments are only examples, which are not meant to restrict the inventive concept to one specific disposition.

The FIGURE is a side view of the mould closing unit F of an injection moulding machine for processing plastics materials and other plasticisable substances, such as ceramic or powdery substances. On a machine base 15 there is a stationary mould carrier 10, which together with a movable mould carrier 11 forms a mould clamping space R for the accommodation of an injection mould M. At least one closing device 12 is provided for the cyclical opening, supplying and closing of the injection mould M. Through the actuation of the drive unit 19, the movable mould carrier 11 is displaced in the direction of the stationary mould carrier 10, the closing force being applied after mould closure, that-is-to-say after the two mould halves have been placed together. This is effected in the exemplified embodiment by means of a closing device, however, it is possible in principle—as is known in the state of the art—to carry out a serial closing, that-is-to-say to close the mould initially with a closing device and then to apply the closing force with a second device.

The closing device 12, which in this case is formed by a toggle mechanism, preferaby a five-point toggle, is activated by the driving means 19. On activation, the closing device 12 is supported on the support, which is formed in the exemplified embodiment by the supporting element 14.

Sensor means are provided in the form of the sensor 13 for detecting the mould securing force and at least the closing forces occurring when the injection mould is closed. In the case of the mould securing force, it is important to ascertain that the mould is not damaged when it is being supplied or when resistances suddenly occur which have to result in the closing operation being stopped. Detecting the closing forces, contrary to this, is necessary to guarantee an appropriate quality of the mouldings. When the mould is closed, plasticised plastics material is injected into the mould cavity of the injection mould via the injection moulding unit S, of which only the nozzle and the plasticising cylinder 16 are to be seen on the right.

The sensor means for detecting both the mould securing force and the closing forces is at least one high resolution surface strain sensor, which is referred to below as sensor 13. This sensor is high resolution in such a manner that it can detect the mould securing force in a reliable and sufficiently precise manner. In order to be able to realise the two goals in as undisturbed manner as possible, the sensor is disposed on the supporting means of the closing device 12, preferably centrally in the axis of injection s-s. Other dispositions are possible, if the stress field is known in order, where applicable, to recalculate the stress to the axis of injection s-s. It is also possible to provide a plurality of sensors if it is guaranteed according to the invention that they can detect both the mould securing force and the closing forces.

In the exemplified embodiment itself, a single sensor 13 is used as the sensor for detecting all the forces. In this case, the sensor can measure over the entire force range with a single measuring range. As the measuring range of the sensor is consequently designed for the closing force or respectively the holding force, the signal of the mould securing force is consequently never saturated during the mould displacement. In other words, the user can allow a value range up to the variable of the maximum closing force for the parameter of the programmable securing force. A changeover of measuring range is therefore not necessary. This statically measuring sensor 13 is disposed centrally on the supporting element 14 of the mould closing unit F. The supporting element 14, in the case of the triple plate machine represented in the FIGURE, is behind the movable mould carrier 11, when viewed with respect to the stationary mould carrier 10. The supporting element 14 is connected to the stationary mould carrier 10 via force transferring means. The force transferring means in the exemplified embodiment are in the form of guide bars 18, which at the same time are for guiding the movable mould carrier. Instead of these, a force transferring means can be provided, for example, in the form of a C-bracket or similar apparatuses with which the forces are conducted around the mould clamping space R. As an alternative, in an exemplified embodiment not shown in the FIGURE, the principle according to the invention can be used on a double plate machine, where the stationary mould carrier at the same time forms the supporting element for the closing device and, for example, the movable mould carrier is drawn towards the stationary mould carrier 10.

Both the closing force and the mould securing force can be measured with the sensor 13. The indirect force measuring supplies a signal in proportion to the desired measuring variable. The strain gauge sensor, which is specifically matched to the application, operates with a mechanical amplification or respectively magnification of the strain. This is preferably a strain transformer. The measuring range is selected in such a manner that at maximum closing force approximately 80% to 90% of the maximum signal stroke is achieved. The minimum programmable mould protection force is defined substantially through the quality of the transmission of the signal and the resolution of the evaluation of the signal connected downstream. However, this resolution is usually also sufficient to detect the mould securing force in a sufficiently precise manner.

The mounting location of the sensor 13 on a non-displaced part where there is a small amount of mechanical strain provides both good accessibility and a clearly reduced mechanical load. Measuring errors when measuring the mould securing force, caused by the lack of plate parallelity or by mouldings that are clamped on one side, are minimised through the central position of the sensor. As one sensor is used for the entire range, the mould securing force can also be arbitrarily programmed by the user.

A reset circuit for compensating for the drift from cycle to cycle in the case of the amplifier circuit connected downstream can be dispensed with due to the mechanical strain amplification of the sensor. For the cyclical measuring of the quasi-static closing force, a resetting of the measuring chain would namely require a force-less condition over the period necessary for the resetting. This period would include at least the reset time of the amplifier, as a rule a few milliseconds, as well as the time for the decay of the system, which in its turn is dependent on the system rigidity and the dynamics in the cycle. This would be expressed as an extension of the cycle time. In addition, a force-less condition of this kind cannot be achieved conventionally with a cyclically operating machine such as the mould closing unit of a plastics injection moulding machine.

The mounting position of the sensor 13 on the supporting means of the closing device 12 is normally to be selected so as to be favourable to the reduction of measuring errors, preferably for the measuring of the mould securing force. In addition, it ought to be selected so as to be favourable to the mechanical and thermal load of the sensor 13 as well as to its accessibility.

It is obvious that this description can be subject to the most varied modifications, changes and adaptations, which range in the region of equivalents to the attached claims.

1-11. (Canceled)

12. Mould closing unit for an injection moulding machine for the processing of plastics materials and other plasticizable substances, said mould closing unit including
a stationary mould carrier, which together with a movable mould carrier forms a mould clamping space for the accommodation of an injection mould,
at least one closing device for the cyclical opening, supplying and closing of the injection mould by moving the movable mould carrier and for the applying of the closing force,
a support for the closing device,
a strain sensor for detecting at least the closing forces occurring when the injection mould is closed wherein the strain sensor is disposed on the support of the closing device,
wherein the strain sensor for detecting both the mould securing force and the closing forces is one high resolution surface strain sensor that comprises only one measuring range for detecting the forces.

13. Mould closing unit according to claim 12, wherein the strain sensor is disposed centrally on the support of the mould closing unit.

14. Mould closing unit according to claim 12, wherein the support is disposed behind the movable mould carrier, when viewed with respect to the stationary mould carrier, which support is connected to the stationary mould carrier via force transferring means.

15. Mould closing unit according to claim 12, wherein the support is formed by the stationary mould carrier.

16. Mould closing unit according to claim 12, wherein the closing device is a toggle mechanism.

17. Mould closing unit according to claim 12, wherein the strain sensor is adapted to be a statically measuring sensor with mechanical amplification.

18. Mould closing unit according to claim 17, wherein the strain sensor is a strain link or strain transformer.

19. Mould closing unit according to claim 12, wherein the maximum closing force is 80% to 90% of the measuring range of the strain sensor.

20. Method for detecting the forces on a mould closing unit with a high resolution surface strain sensor, which is disposed on the support of the closing device and measures with mechanical amplification and with no reset and with only one measuring range.
